(19) United States
(12) Patent Application Publication
(10) Pub. No.: US 2013/0244851 A1
(43) Pub. Date: Sep. 19, 2013

(54) Apparatus for processing sheets of paper material

(71) Applicants: Giuseppe BRIVIO, Besana Brianza (Monza Brianza) (IT); Renato ROSSI, Biassono (IT)

(72) Inventors: Giuseppe BRIVIO, Besana Brianza (Monza Brianza) (IT); Renato ROSSI, Biassono (IT); Piermario ROSSO, Asti (Asti) (IT)

(73) Assignee: BP AGNATI S r. L., Vimercate (Monza Brianza) (IT)

(21) Appl. No.: 13/540,971

(22) Filed: Jul. 3, 2012

(30) Foreign Application Priority Data
Jul. 4, 2011 (IT) MI2011A001243

(51) Int. Cl. B31F 1/28; B31F 5/04

(52) U.S. Cl. CPC B31F 1/2818; B31F 5/04
USPC 493/335; 493/463; 493/337

(57) ABSTRACT

An apparatus (1) for processing sheets of paper material, comprising: a calender (2) adapted to treat at least one sheet of paper material and including a first cylinder (3) and a second cylinder (4), the first cylinder (3) comprising a work wall (3a) of composite material, forming the outer work surface (3c) of the first cylinder (3) and a support body (3b) having an outer surface coaxial to and in contact with the work surface (3a), the first cylinder (3) being obtained by fitting of the work surface (3a) on the support body (3b).

### RELATED APPLICATIONS

This application claims foreign priority based on Italian patent application MI2011A001243 filed on Jul. 4, 2011

### FIELD OF THE INVENTION

The present invention relates to an apparatus for processing sheets of paper material, in particular of corrugated cardboard, and including a first cylinder and a second cylinder.

### DESCRIPTION OF THE PRIOR ART

Presently known are different types of apparatus for processing sheets of paper material adapted to manufacture corrugated cardboard, or also multilayer cardboard, coupled sheets, paper panels or carry out still other processing operations connected with sheets of paper material.

In particular, the corrugated cardboard is made up of at least one corrugated sheet suitably connected to one or more smooth sheets, glued to the corrugated sheet itself along one or both faces thereof.

It is manufactured by suitable apparatus adapted to corrugate at least one sheet of paper material and carry out coupling between said corrugated sheet and a smooth sheet by gluing.

In particular, a sheet of paper material is passed through a first calender, in which at least one of the cylinders forming it is provided with a corrugated surface adapted to form the grooves and ridges of the corrugated sheet. The same sheet is then passed through a second calender, preferably having a cylinder in common with the first calender and adapted to coat the corrugated sheet with a film of glue.

A smooth sheet of paper material is subsequently glued to the corrugated sheet.

Gluing takes place through passage of the two sheets through a third calender comprising one of the cylinders of the first calender and a steel cylinder that is steam heated and is adapted to enable gluing of the two sheets.

The known art mentioned above has some important drawbacks.

In fact, the processing speeds of said apparatus are very high, to such an extent that said cylinders work at hypercritical speeds, i.e. above the resonance frequency to which the vibrations of the cylinders themselves have a maximum value. Consequently said cylinders, and in particular the steel cylinder being part of the third calender, in their acceleration, go through said critical speed and the related harmonics.

This critical speed can give rise to breaking of the sheets of paper material. In particular, recent formation of corrugated sheets obtained from very thin sheets of paper material have problems connected with breaking, when said apparatus of known type are used.

Breaking causes a reduction in the quality of the produced cardboard and sometimes the production has to be stopped which involves an increase in costs; as a result, it is impossible to reduce the paper basis weight.

This drawback has been partly remedied by apparatus carrying out gluing through superposition of a cylinder and a tensioned tape adapted to press the sheets of paper material against the cylinder.

However, these apparatus are able to apply reduced gluing pressures, that are not sufficient to carry out gluing of some types of corrugated cardboard. Another known partial solution consists in providing a first external cylinder of an inner diameter greater than a second cylinder coaxial with the first one and supporting it. Thus the first cylinder freely moves around the second cylinder, oscillating and becoming partly deformed.

The first cylinder is not therefore closely linked to the axis and does not give too much pressure to the paper thus preventing it from breaking.

However, these apparatus too are only able to apply reduced gluing pressures that are not sufficient to carry out gluing of some types of corrugated cardboard.

The drawback has been also partly obviated by the apparatus described in the Patent Application EP-A-0970805 that is provided with a third calender in which the steel cylinder is surrounded by a surface layer made of composite or paper material. This cylinder is then supported by a pressure cylinder, adapted to support the cylinder itself in a thrust direction.

In addition, during use, the surface layer becomes partly deformed at the region in contact with the paper and therefore heated and can be consequently damaged.

Furthermore, if the apparatus carries out processing operations on paper of reduced width alternated with processing operations on paper of larger width, the second paper is submitted to unhomogeneous processing exactly due to said deformations.

### SUMMARY OF THE INVENTION

Under this situation, the technical task underlying the present invention is to provide an apparatus for processing sheets of paper material capable of substantially obviating the mentioned drawbacks.

Within the scope of this technical task, it is an important aim of the invention to obtain an apparatus for processing sheets of paper material that does not show process inconveniences such as breaking or damages to the sheets.

Another important aim of the invention is to make available an apparatus for processing sheets of paper material enabling high processing pressures and in particular high gluing pressures to be obtained.

It is a further aim of the invention to provide an apparatus for processing sheets of paper material that is simple and cheap.

The technical task and the aims specified are achieved by an apparatus for processing sheets of paper material comprising: a calender adapted to treat at least one sheet of paper material and including a first cylinder and a second cylinder, the first cylinder comprising a work wall of composite material constituting the outer work surface of the first cylinder, and a support body having an outer surface coaxial to and in contact with the work wall, further the first cylinder is obtained through fitting of said work surface on said support body.

### BRIEF DESCRIPTION OF THE DRAWINGS

The features and advantages of the invention are hereinafter clarified by the detailed description of a preferred embodiment of the invention, with reference to the accompanying drawings, in which:

FIG. 1 diagrammatically shows a sectional side view of the apparatus according to the invention;

FIG. 2a is a longitudinal section of a portion of the processing apparatus according to the invention in a first configuration;

FIG. 2b shows a longitudinal section of a portion of the processing apparatus according to the invention in a second configuration;

FIG. 3 is a cross-section of the portion shown in FIG. 2; and

FIG. 4 shows a further detail of the apparatus according to the invention.

### DESCRIPTION OF THE PREFERRED EMBODIMENTS

With reference to the mentioned figures, the apparatus for processing sheets of paper material according to the invention is generally identified with reference numeral 1.

It suitably consists of an apparatus 1 adapted to form at least part of membranes of corrugated cardboard 20, of the single-face or “nude” wave type for example.

Apparatus 1 comprises a calender adapted to process at least one sheet of paper material and including a first cylinder 3 and a second cylinder 4.

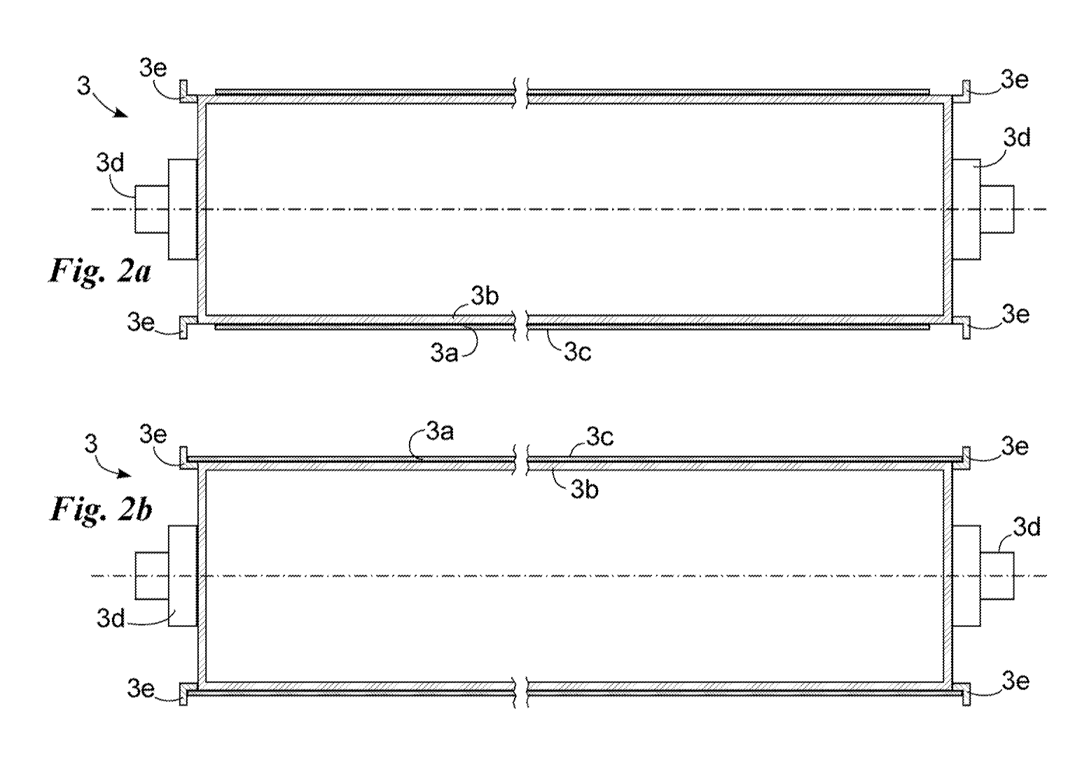

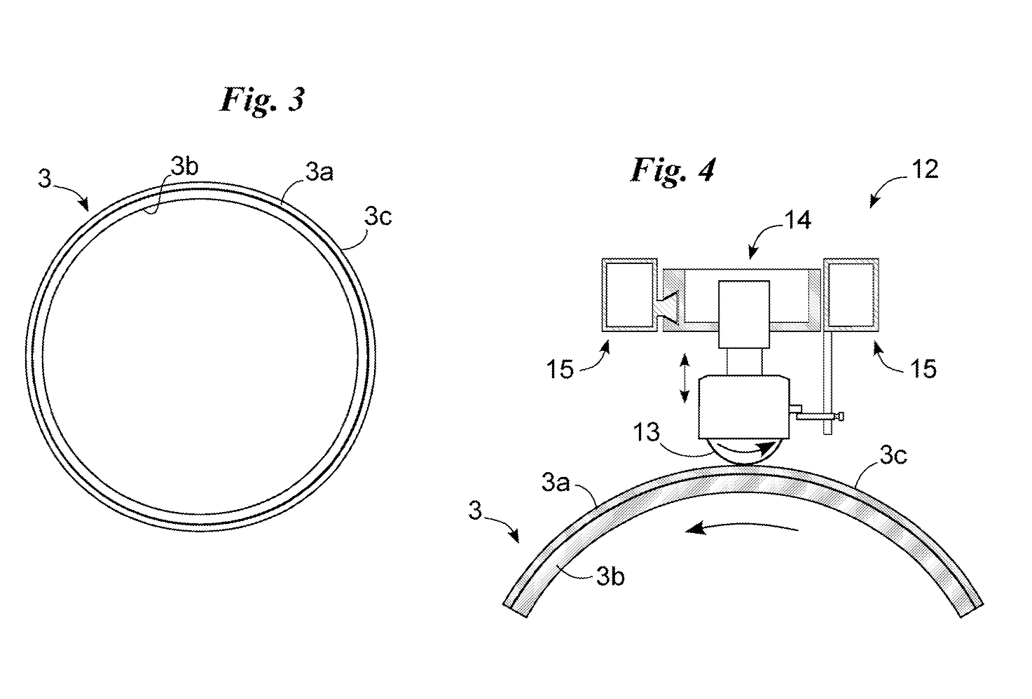

The first cylinder 3 briefly comprises a work wall 3a forming the outer work surface 3c of the first cylinder 3 and a support body 3b having an outer surface coaxial to and in contact with the work surface 3a (FIGS. 2a, 2b and 3).

The support body 3b too is preferably hollow. The work surface 3a and the portion of the support body 3b in contact therewith therefore substantially constitute the side wall of the first cylinder 3, as shown in FIGS. 2a, 2b and 3. Suitably, the support body 3b further comprises side necks 3d adapted to rotatably connect the first cylinder 3 to the remaining part of apparatus 1 and side supports 3e adapted to hold said work surface 3a in the axial direction, as better specified hereinafter.

The work wall 3a is substantially made of composite material, more preferably of fibre-composite material with polymeric matrix. The materials constituting said work wall 3a have a heat expansion coefficient suitably included between 10⁻⁵[1/° C.] and 10⁻⁴[1/° C.] at the use temperatures.

In addition, the work wall 3a has thickness suitably included between 5 mm and 100 mm, a base diameter and a width close to those of known cylinders, and in particular included between 0.3 m and 0.6 m and between 1.2 m and 3.5 m, respectively.

The work wall 3a is further made independently of said support body 3b and therefore is not a simple surface coating applied thereto. It is also advantageously coupled to said support body 3a through a fitting process. A known procedure is in fact adopted which consists in manufacturing two parts to be coupled by mechanical interference fit.

The support body 3b is on the contrary made of metal material, in particular steel and more particularly carbon steel. It has therefore a heat expansion coefficient suitably included between 12.10⁻⁶[1/° C.] and 14·10⁻⁶[1/° C.] at the use temperatures.

Preferably it is not heated, but as an alternative it could be steam heated inside the cavity of the support body 3b, as it happens in metal cylinders of the known art.

The calender 2 is preferably adapted to couple a first sheet 21 to a second sheet 22 by gluing, in particular by hot gluing.

Both sheets 21 and 22 are of paper material and the second sheet 22 is suitably corrugated, while the first sheet is preferably smooth.

In addition, the first cylinder 3 is preferably directly in contact with the first sheet 21, while the second sheet 4 is preferably directly in contact with the second sheet 22.

To this aim, the second cylinder 4 has a suitably corrugated work surface. Apparatus 1 further comprises glue coating means 5.

This means is adapted to coat the second sheet 22 with glue and in particular to coat the face of the second sheet that will come into contact with the first sheet 21 with a glue layer 23. The means 5 is disposed upstream of calender 2 and in the vicinity thereof, so that the glue does not react before contact between sheets 21 and 22. The coating means 5 is preferably known by itself and used in apparatus for making membranes of corrugated cardboard 20. In particular it is formed with a gluing calender 6 consisting of a gluing cylinder 7 and with the second cylinder 4. The gluing cylinder 7 is adapted to be dipped into a gluing tank 8 and dispose a glue layer 23 on the second sheet 22.

Apparatus 1 preferably further comprises a calender 9 upstream of the calender 2 and gluing calender 6, adapted to carry out corrugation on the second sheet 22.

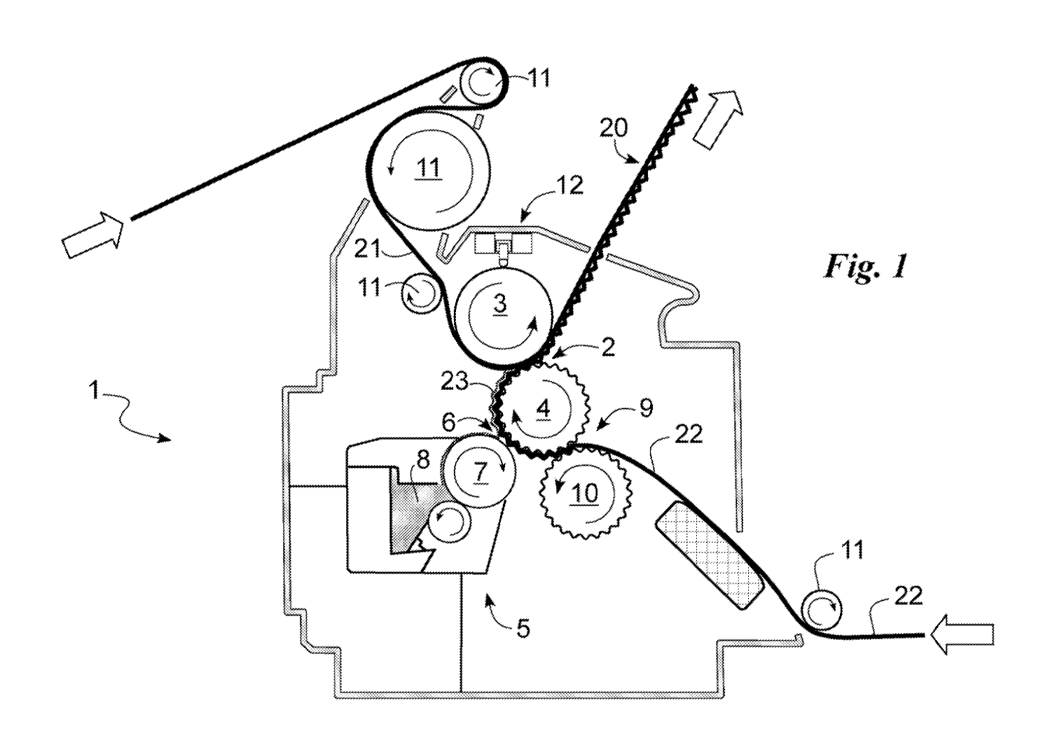

Calender 9 comprises the second cylinder 4 and a third cylinder 10 in turn provided with a suitably corrugated work surface. The third cylinder preferably further has smaller sizes than the first cylinder and is suitably cushioned, as described in paragraph 18 and FIG. 1 of the European Patent EP-B-0970805. The second and third cylinders 4 and 10 are preferably further made of steel and steam heated at the inside, so as to enable corrugation of the second sheet 22.

In addition, the high temperature of the second cylinder 4 also has influence on gluing of the two sheets 21 and 22 and allows the correct physico-chemical reactions enabling gluing to take place.

The first cylinder, on the contrary and as said, preferably is at room temperature. Then, further feeding cylinders 11 can be provided which are adapted to orient sheets 21, 22 and membrane 20 and also possibly to heat the membrane or the glue layer 23.

Not required are on the contrary pressure cylinders adapted to counteract the first cylinder 3, in contrast with the force applied by the latter as part of calender 2. Cylinder 3 in fact has high resistance to bending and is also suitably convex. In particular, the diameter of the central portion thereof is different from the diameter of the peripheral portions.

Finally, apparatus 1 preferably comprises forming or profiling means 12 (FIG. 4) adapted to grind the outer surface 3c of composite material of the first cylinder 3. This profiling means comprises a tool 13, adapted to come into contact with the outer surface 3c of the work surface and consisting of a grinding wheel or sand belt or other type of tool, moved by rotary or fixed supports. The profiling means 12 then comprises positioning means 14 for tool 13 relative to the outer surface 3c and sliding means 15 for the tool on the outer surface 3c. The profiling means 12 therefore allows the whole surface 3c to be machined, are fully adjustable and finally suitably automated through a programmable logic controller (PLC) or the like.

Operation of the apparatus for processing sheets of paper material described above in terms of structure, is the following.

Apparatus 1 is activated and the first sheet 21 and second sheet 22 are inserted through suitable paths defined by the feeding cylinders 11.

In particular, the second sheet 22 first of all passes through calender 9 where it is corrugated by pressure, the corrugated surfaces and heat present in the second 4 and third 10 cylinders.

The second sheet 22 is therefore corrugated and passes through the coating means 5 that, by means of the gluing calender 6, gluing cylinder 7 and gluing tank 8, coat the second sheet 22 with a glue layer 23.

The second sheet 22 including the glue layer 23 and the first sheet 21 then pass through calender 2, where they are mutually glued by the pressure exerted by the first cylinder 3 and second cylinder 4 made of steel and internally heated.

Calender 2 therefore exerts pressure and supplies enough heat to allow gluing of sheets 21 and 22 that will therefore form a single membrane of corrugated cardboard 20.

During normal use of apparatus 1 the profiling means 12 remains to a distance from the first cylinder 3 and in particular tool 13 is spaced apart from the outer surface 3c.

However, the outer surface 3c of the first cylinder 3 that is part of the work wall 3a of composite material, can be subjected to wear more quickly than the other portions.

In this case the profiling means 12 can be operated and the amount of overall surface of the first cylinder to be removed along the whole surface of the cylinder can be adjusted, as mentioned before.

This operation is feasible in particular during the idling time or when the plant is not running, without this involving inaccuracies, because the plant is fully automated and because these machining operations can be carried out when the machine is cold.

The invention also comprises a new process for making an apparatus including a first cylinder 3 as previously described. This process comprises the described steps of fitting the work surface 3a on the support body 3b at the stated temperatures and carrying out grinding through means 12.

The invention achieves important advantages.

The first cylinder, made of the materials pointed out above, in fact has a surface less hard than that of steel and consequently does not cause damages or breaking of the sheets 21 and 22, not even if they have a very reduced basis weight.

In addition, it has been seen that sheets 21 and 22 are glued, in spite of the fact that the first cylinder 3 is substantially at room temperature, as previously said.

Furthermore, the Applicant has found that, due to said fitting operation, due to the inherent features of the materials and finally also due to the selected sizes, the machining operations and the heat resulting from said operations do not cause uncontrolled deformation in the radial direction of the work wall 3a.

Consequently, the work wall 3a remains always firmly secured to the support body 3b.

In addition, when the work surface 3a is submitted to the high processing temperatures, it extends in a controlled manner also in the longitudinal direction (FIG. 2b). This expansion does not involve any disadvantage.

A further important advantage is finally given by the profiling means 12 enabling quick grinding of the first cylinder 3 without stopping the apparatus, as previously described.

In fact, the first cylinder 3, having a work surface 3a made of composite material, is subject to wear more frequently than cylinders 4 and 10 made of steel.

The invention is susceptible of variations falling within the scope of the inventive idea set out in the independent claims.

In particular the invention can be also used for producing multi-layer cardboard, coupled sheets, paper panels, in all cases in which at least two paper layers have to be mutually engaged by gluing between calenders or other machining operations still related to sheets of paper material.

All of the details can be replaced by equivalent elements and the materials, shapes and sizes can by of any nature and magnitude.

1. An apparatus (1) for processing sheets of paper material, comprising: a calender (2) adapted to treat at least one sheet of paper material and including a first cylinder (3) and a second cylinder (4), and wherein said first cylinder (3) comprises a work wall (3a) of composite material constituting the outer work surface (3c) of said first cylinder (3), and a support body (3b) having an outer surface coaxial to and in contact with said work wall (3a) and in that said first cylinder (3) is obtained through fitting said work surface (3a) on said support body (3b).

2. An apparatus (1) as claimed in claim 1, wherein said work wall (3a) is made of fibre-composite material with a polymeric matrix and said support body is made of metal.

3. An apparatus (1) as claimed in claim 1, wherein said work wall (3a) has a heat expansion coefficient between 10⁻⁵[1/° C.] and 10⁻⁴[1/° C.].

4. An apparatus (1) as claimed in claim 1, wherein said work wall (3a) has thickness between 5 and 100 mm.

5. An apparatus (1) as claimed in claim 1, further comprising profiling means (12) to form said first cylinder (3).

6. An apparatus (1) as claimed in claim 1, adapted to make at least part of membranes of corrugated cardboard (20).

7. An apparatus (1) as claimed in claim 1, wherein said calender (2) is capable of joining a first sheet (21) and a second sheet (22) of paper material by gluing them and wherein said second sheet (22) is corrugated and wherein said first cylinder (4) is in direct contact with said first sheet (21).

8. An apparatus (1) as claimed in claim 1, wherein said first cylinder (3) is not in direct contact with further cylinders, except for said second cylinder (4), and is substantially at room temperature.

9. A process for making an apparatus (1) for processing sheets of paper material, said apparatus (1) comprising: a calender (2) adapted to process at least one sheet of paper material and wherein said first cylinder (3) and a second cylinder (4) and characterised in that said first cylinder (3) comprises a work wall (3a) of composite material constituting the outer work surface (3c) of said first cylinder (3), and a support body (3b) having an outer surface coaxial to and in contact with said work wall (3a) and in that said work wall (3a) is fitted on said support body (3b).
